(19) United States
(12) Patent Application Publication
(10) Pub. No.: US 2026/0225649 A1
(43) Pub. Date: Aug. 6, 2026

(54) SATURATION ALGORITHM FOR STEER-BY-WIRE SYSTEM FOR A VEHICLE

(71) Applicant: GM Global Technology Operations LLC, Detroit, MI (US)

(72) Inventors: Amin Habibnejad Korayem, Markham (CA); Seyedeh Asal Nahidi, North York (CA); SeyedAlireza Kasaiezadeh Mahabadi, Novi, MI (US); Philip C. Lundberg, Sylvan Lake, MI (US)

(73) Assignee: GM Global Technology Operations LLC, Detroit, MI (US)

(21) Appl. No.: 19/046,073

(22) Filed: Feb. 5, 2025

(51) Int. Cl. B62D 6/00; B62D 5/04

(52) U.S. Cl. CPC B62D 6/008; B62D 5/0469

(57) ABSTRACT

A computer-implemented method when executed by data processing hardware causes the data processing hardware to perform operations. The operations include receiving, at a saturation algorithm of a steer-by-wire (SbW) module, vehicle data from a steering wheel actuator and a road wheel actuator, generating, based on the received vehicle data, a self-aligning torque estimation, and determining, via the saturation algorithm, a pneumatic trail estimation based on the self-aligning torque estimation and a lateral axle force estimation. The operations also include generating, via the saturation algorithm, a lateral axle saturation based on the pneumatic trail estimation, executing, based on the lateral axle saturation a steering output via the saturation algorithm, and executing, via the SbW module, a notification corresponding to the steering output.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a steer-by-wire system for a vehicle.

Vehicles are equipped with steering mechanisms including a steering wheel that is mechanically connected to wheels of the vehicle. Many steering mechanisms include a steering shaft, column, or other mechanical structure to couple or otherwise provide steering movement between the steering wheel and the wheels. Some vehicles may be equipped with steer-by-wire, which provides steering between the steering wheel and the wheels without the use of the steering column. Steer-by-wire removes mechanical connections and utilizes a relationship between the steering wheel and the wheels, such that the wheels are responsive to a degree of movement of the steering wheel. However, many steer-by-wire implementations may not account for changes in acceleration or lateral movement of the vehicle that may affect the steering wheel movement relative to the degree of movement of the steering wheel. In particular, steer-by-wire implementations may not account for saturation that may occur in the lateral direction that may result in destabilization of the vehicle. Thus, there is a need for an improved steer-by-wire system.

### SUMMARY

In some aspects, a computer-implemented method when executed by data processing hardware causes the data processing hardware to perform operations. The operations include receiving, at a saturation algorithm of a steer-by-wire (SbW) module, vehicle data from a steering wheel actuator and a road wheel actuator, generating, based on the received vehicle data, a self-aligning torque estimation, and determining, via the saturation algorithm, a pneumatic trail estimation based on the self-aligning torque estimation and a lateral axle force estimation. The operations also include generating, via the saturation algorithm, a lateral axle saturation based on the pneumatic trail estimation, executing, based on the lateral axle saturation a steering output via the saturation algorithm, and executing, via the SbW module, a notification corresponding to the steering output.

In some examples, the vehicle data may include a steering wheel angle, a steering wheel torque, and dampening friction. Optionally, generating the self-aligning torque estimation may include determining a total self-aligning torque based on the vehicle data. In some instances, executing the steering output may include executing a steering ratio adjustment via the saturation algorithm. In further examples, the steering ratio adjustment may include a ratio between a steering wheel angle and a road wheel angle. Optionally, executing the steering output may include executing a torque feedback adjustment. In other examples, executing the notification includes issuing a haptic notification at one or more of a steering wheel and a driver seat of a vehicle. In further instances, executing the notification may include issuing the notification at a head-up display of a vehicle.

In other aspects, a steer-by-wire (SbW) system for a vehicle includes data processing hardware and memory hardware in communication with the data processing hardware. The memory hardware stores instructions that when executed on the data processing hardware cause the data processing hardware to perform operations. The operations include receiving, at a saturation algorithm of a steer-by-wire (SbW) module, vehicle data from a steering wheel actuator and a road wheel actuator, generating, based on the received vehicle data, a self-aligning torque estimation, and determining, via the saturation algorithm, a pneumatic trail estimation based on the self-aligning torque estimation and a lateral axle force estimation. The operations also include generating, via the saturation algorithm, a lateral axle saturation based on the pneumatic trail estimation, executing, based on the lateral axle saturation a steering output via the saturation algorithm, and executing, via the SbW module, a notification corresponding to the steering output.

In some examples, the vehicle data may include a steering wheel angle, a steering wheel torque, and dampening friction. Optionally, executing the steering output may include executing a steering ratio adjustment via the saturation algorithm. In some instances, the steering ratio adjustment may include a ratio between a steering wheel angle and a road wheel angle. In other examples, executing the steering output may include executing a torque feedback adjustment. Optionally, executing the torque feedback adjustment may include increasing a torque stiffness defined at a steering wheel. In further examples, executing the notification may include issuing a haptic notification at one or more of a steering wheel and a driver seat of a vehicle. In further instances, executing the notification may include issuing the notification at a head-up display of a vehicle.

In further aspects, a steer-by-wire (SbW) system for a vehicle includes data processing hardware and memory hardware in communication with the data processing hardware. The memory hardware stores instructions that when executed on the data processing hardware cause the data processing hardware to perform operations. The operations include receiving, at a saturation algorithm of a steer-by-wire (SbW) module, vehicle data from a steering wheel actuator and a road wheel actuator, the vehicle data including a steering wheel angle, a steering wheel torque, and dampening friction, determining, via the saturation algorithm, a total self-aligning torque based on the vehicle data, generating, based on the determined total self-aligning torque, a self-aligning torque estimation, and determining, via the saturation algorithm, a pneumatic trail estimation based on the self-aligning torque estimation and a lateral axle force estimation. The operations also include generating, via the saturation algorithm, a lateral axle saturation based on the pneumatic trail estimation, executing, based on the lateral axle saturation, a steering output via the saturation algorithm, and issuing, via the SbW module, a notification corresponding to the steering output.

In some examples, executing the steering output may include executing a steering ratio adjustment via the saturation algorithm. The steering ratio adjustment may include a ratio between a steering wheel angle and a road wheel angle. Optionally, executing the steering output may include executing a torque feedback adjustment and increasing a torque stiffness defined at a steering wheel.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with a steer-by-wire (SbW) system according to the present disclosure;

FIG. 2 is an exemplary block diagram of an SbW system according to the present disclosure;

FIG. 3 is a partial perspective view of an interior of a vehicle according to the present disclosure, the vehicle including a steering wheel and a user interface;

FIG. 4 is an example flow diagram for an SbW system according to the present disclosure; and

FIG. 5 is an example flow diagram of a method of executing an SbW system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

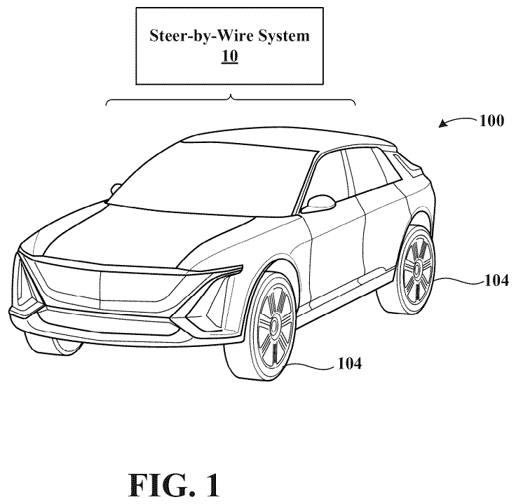

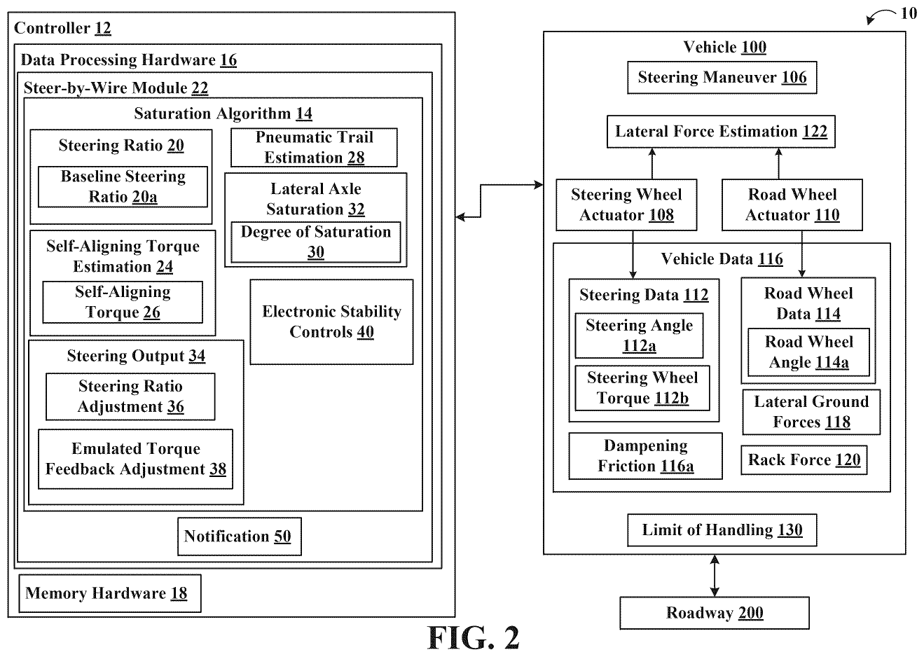

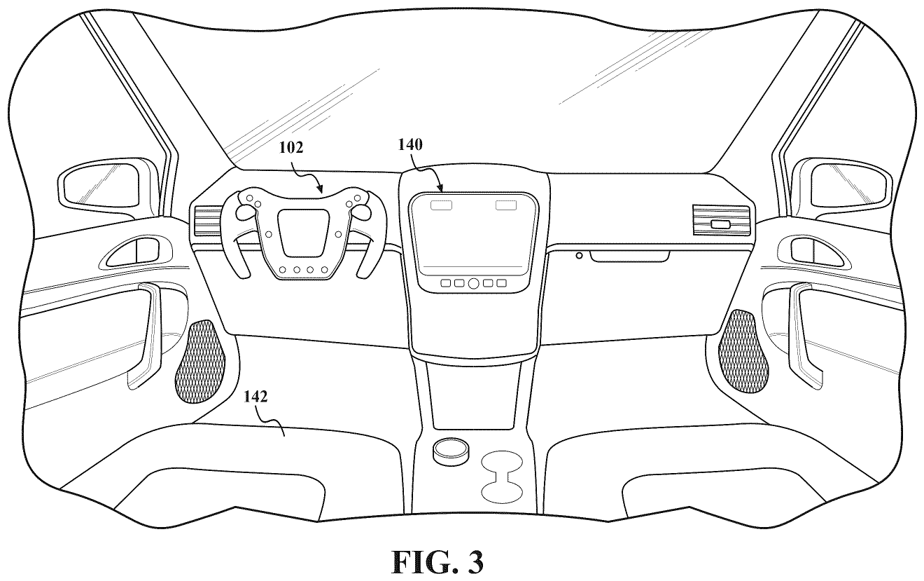

Referring to FIGS. 1-3, a vehicle 100 is equipped with a steer-by-wire (SbW) system 10. The SbW system 10 is configured to manipulate or otherwise execute controls between a steering wheel 102 and road wheels 104 of the vehicle 100. The steering wheel 102 is communicatively and operably coupled to each of the road wheels 104 via the SbW system 10 to execute a steering maneuver 106 of the vehicle 100. The steering wheel 102 may be configured as a traditional, rounded or circular steering wheel 102 or may be configured as a yolk steering wheel 102. The steering wheel 102 and the road wheels 104 include, respectively, a steering wheel actuator 108 and a road wheel actuator 110. The steering wheel actuator 108 is configured to capture steering data 112 associated with the steering wheel 102. The road wheel actuator 110 is configured to capture road wheel data 114 associated with each of the road wheels 104. The steering data 112 and the road wheel data 114 may be included as part of vehicle data 116 provided to the SBW system 10. The vehicle data 116 may also include, but is not limited to, lateral acceleration, a yaw rate, and a vehicle speed. The steering data 112 may include, but is not limited to, a steering angle 112a and steering wheel torque 112b.

The SbW system 10 includes a controller 12 that is configured with a saturation algorithm 14 that is configured to receive the steering data 112 and the road wheel data 114 from the steering wheel 102 and the road wheels 104. The controller 12 also includes data processing hardware 16 that is configured to execute the saturation algorithm 14. The data processing hardware 16 is in communication with memory hardware 18 that stores instructions that, when executed by the data processing hardware 16, cause the data processing hardware 16 to perform operations, described herein. The saturation algorithm 14 is configured with a steering ratio 20 associated with the SbW system 10. For example, the saturation algorithm 14 may be initially calibrated with a baseline steering ratio 20a. The baseline steering ratio 20a may also be established after a predetermined duration of operative time of the vehicle 100.

The steering ratio 20 reflects the effect of the steering angle 112a on a road wheel angle 114a. For example, the greater the steering ratio 20 the less of an effect the steering angle 112a will have on the road wheel angle 114a. In other words, an operator will manipulate the steering wheel 102 to a greater steering angle 112a in order to result in a desired change in the road wheel angle 114a when the steering ratio 20 is high. Comparatively, a lower or lesser steering ratio 20 may provide the operator with the ability to make minor changes to the steering angle 112a to effectuate a greater change in the road wheel angle 114a. Thus, the road wheels 104 may have an increased responsiveness to the steering wheel 102 when the steering ratio 20 is small and may have a decreased responsiveness to the steering wheel 102 when the steering ratio 20 is large. Further, the steering ratio 20 is influenced by the other vehicle data 116, in addition to the steering angle 112a and the road wheel angle 114a, including, but not limited to, the lateral acceleration, the yaw rate, and the vehicle speed at an initial measurement.

With further reference to FIGS. 1-3, the saturation algorithm 14 is configured as part of a steer-by-wire (SbW) module 22 at which the vehicle data 116 is received from the steering wheel actuator 108 and the road wheel actuator 110. Based on the vehicle data 116, the saturation algorithm 14 is configured to execute a self-aligning torque estimation 24. The self-aligning torque estimation 24 may correspond to a moment where the vehicle 100 may become unstable based on the steering wheel torque 112b relative to the road wheels 104. The saturation algorithm 14 is configured to estimate, via the self-aligning torque estimation 24, the moment where the vehicle 100 may become unstable based on the vehicle data 116 provided. The steering wheel actuator 108 may include a torque sensor 108a. The torque sensor 108a provides the SbW system 10 with driver input data (i.e., the steering data 112) at the steering wheel 102, such that driver input torque is measurable via the torque sensor 108a.

The road wheel actuator 110 may also include a rack and pinion sensor 110a that may capture a pinion angle (i.e., as part of the road wheel data 114) that is measurable via the rack and pinion sensor 110a. Thus, the saturation algorithm 14 may determine a total self-aligning torque 26 based on the vehicle data 116 (i.e., the driver input torque from the steering data 112 and the pinion angle from the road wheel data 114). For example, the saturation algorithm 14 receives the road wheel data 114 and the steering data 112, which includes data pertaining to lateral tire forces 118 that are applied at the road wheels 104. The saturation algorithm 14 may utilize the lateral tire forces 118 as part of the self-aligning torque estimation 24 to estimate the self-aligning torque 26.

For example, the steering wheel actuator 108 and the road wheel actuator 110 may estimate the lateral ground forces 118. The road wheel actuators 110 may detect a motor current related to a rack force 120 at a steering axis 102a of the steering wheel 102. The rack force 120 may be included as part of the vehicle data 116 and may be utilized by the saturation algorithm 14 and/or the actuators 108, 110 to estimate the lateral tire forces 118 via a lateral axle force estimation 122. The lateral axle force estimation 122 utilizes signals from the actuators 108, 110 to estimate the lateral tire forces 118. The lateral tire forces 118 may be determined based on how much force is provided in a lateral direction at the road wheels 104. As mentioned above, the saturation algorithm 14 utilizes the lateral tire forces 118 estimated and provided by the steering wheel actuator 108 and the road wheel actuators 110 to estimate the self-aligning torque 26 using the self-aligning torque estimation 24. For example, a real-time dynamic estimation method (i.e., the lateral axle force estimation 122) is utilized to estimate the lateral tire forces 118.

The self-aligning torque 26 is configured to approach zero (0) when plotted with the steering wheel angles 112a of the steering data 112 at a limit of handling 130 of the vehicle 100. As the steering wheel torque 112b increases, the road wheels 104 may begin to lose grip relative to a roadway 200 on which the vehicle 100 is traveling. For example, the road wheels 104 may begin to lose grip in a lateral direction relative to the roadway 200. Loss of lateral grip at the road wheels 104 may result in sliding of the vehicle 100 relative to the roadway 200. Thus, the saturation algorithm 14 is configured to adjust the steering wheel torque 112b based on the self-aligning torque 26 estimated by the self-alignment torque estimation 24.

The saturation algorithm 14 may utilize the self-aligning torque estimation 24 and the lateral axle force estimation 122 to determine a pneumatic trail estimation 28. The pneumatic trail estimation 28 provides an indication to the saturation algorithm 14 as to a degree of saturation 30 of a calibratable lateral axle saturation 32. The degree of saturation 30 may indicate a degree to which the vehicle 100 may slide relative to the roadway 200. For example, the saturation algorithm 14 is configured to generate, based on the pneumatic trail estimation 28, the calibratable lateral axle saturation 32. In some instances, the calibratable lateral axle saturation 32 may be at a degree of saturation 30 that may indicate potential for sliding of the vehicle 100. The saturation algorithm 14 may execute a steering output 34 in response to the determined degree of saturation 30 and based on the lateral axle saturation.

The steering output 34 may include at least one of a steering ratio adjustment 36 and an emulated torque feedback adjustment 38. For example, the saturation algorithm 14 may execute the steering ratio adjustment 36, which directly alters the steering ratio 20 of the steering wheel 102 relative to the road wheels 104. The execution of the steering ratio adjustment 36 alters the steering ratio 20 to reduce an input via the steering wheel angle 112a, such that the resultant steering wheel angle 112a may be less sensitive to incremental driver inputs at the steering wheel 102. The reduction in sensitivity via the steering ratio adjustment 36 occurs when the saturation algorithm 14 determines the degree of saturation 30 is approaching the calibratable lateral axle saturation 32 (i.e., slippage of the road wheels 104 relative to the roadway 200).

The saturation algorithm 14 may alternatively execute the emulated torque feedback adjustment 38, which is configured to alter the steering wheel torque 112b. For example, the saturation algorithm 14 may increase a torque stiffness of the steering wheel torque 112b defined at the steering wheel 102, such that the steering wheel 102 becomes harder to rotate at the limit of handling 130. If the saturation algorithm 14 detects the lateral axle saturation, as described above, the steering wheel torque 112b may be increased. As a result, a degree of force exerted at the steering wheel 102 by the driver may be increased in order to effectuate a change of the road wheels 104. The increased steering wheel torque 112b results in maintaining the vehicle 100 below the limit of handling 130, which maintains the stability of the vehicle 100. The saturation algorithm 14 may also activate electronic stability controls 40 to further assist in maintaining the stability of the vehicle 100. The saturation algorithm 14 may activate the electronic stability controls 40 based on the detected approach of the limit of handling 130 via the calibratable lateral axle saturation 32.

With further reference to FIGS. 1-3, the SbW module 22 may issue a notification 50 in response to the steering output 34 generated by the saturation algorithm 14. For example, the SbW module 22 may issue the notification 50 to the driver to indicate the approach of the limit of handling 130 and execution of the steering output 34 by the saturation algorithm 14. The notification 50 corresponds to the steering output 34, such that upon execution of the steering output 34, the SbW module 22 issues the notification 50. The notification 50 may specifically indicate to the driver which steering output 34 is being executed. For example, the notification 50 may be displayed at a head-up display (HUD) and/or user interface 140 of the vehicle 100. The notification 50 may be presented as text on the HUD 140 and/or as an icon to indicate the execution of the steering output 34.

Additionally or alternatively, the notification 50 may be issued as a haptic notification for the driver. The haptic notification 50 may be issued at one or more of the steering wheel 102 and/or a driver seat 142 of the vehicle 100. The notification 50 is configured to notify the driver that the vehicle 100 is approaching the limit of handling 130. The driver may adjust inputs to the steering wheel 102 and may also be alerted that the saturation algorithm 14 is executing the steering output 34 corresponding to at least one of the steering ratio adjustment 36 and the emulated torque feedback adjustment 38. The notification 50 may also include preventative torque feedback in steering. For example, the notification 50 may correspond with the steering output 34 implementing resistance torque at the steering wheel 102. The resistance torque may prevent the driver from increasing a steering input during a period associated with the determined calibratable lateral axle saturation 32.

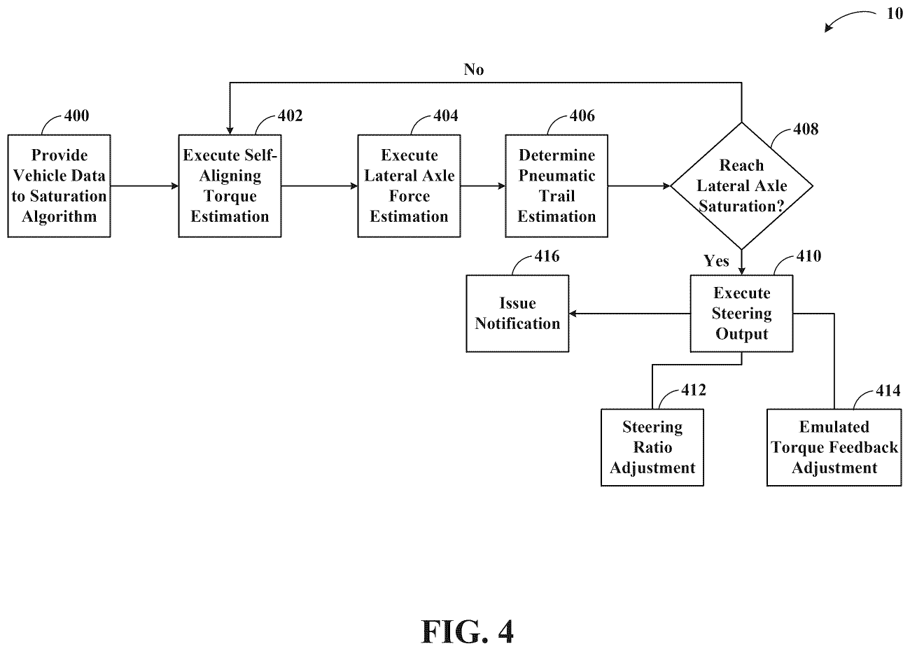

Referring to FIG. 4, an example flow diagram of operations of the SbW system 10 is illustrated. At 400, the vehicle data 116 is provided to the saturation algorithm 14, and at 402, the saturation algorithm 14 executes the self-aligning torque estimation 24. At 404, the lateral axle force estimation 122 is executed and provided to the saturation algorithm 14. The saturation algorithm 14 determines, at 406, the pneumatic trail estimation 28 based on the self-aligning torque estimation 24 and the lateral axle force estimation 122. At 408, the saturation algorithm 14 determines whether the degree of saturation 30 has reached a calibratable lateral axle saturation 32. If not, then the saturation algorithm 14 returns to running the self-aligning torque estimation 24, at 402.

If the degree of saturation 30 has reached the calibratable lateral axle saturation 32, then the saturation algorithm 14 executes, at 410 the steering output 34. For example, the saturation algorithm 14 may execute, at 412, the steering ratio adjustment 36. In other instances, the saturation algorithm may execute, at 414, the emulated torque feedback adjustment 38. Once the saturation algorithm 14 has executed the steering output 34, the SbW module 22 issues, at 416, the notification 50 to the driver.

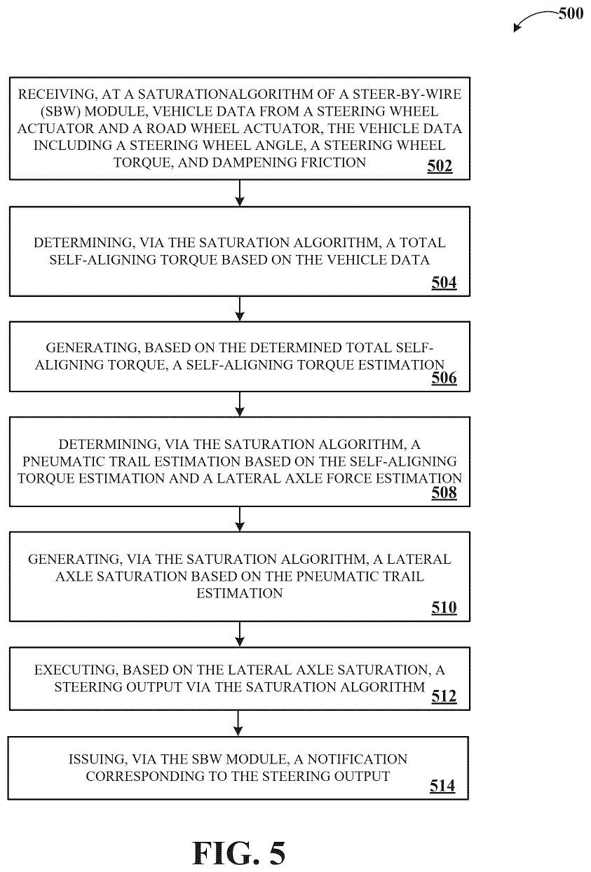

With reference to FIG. 5, a method 500 for executing the steer-by-wire (SbW) system 10 is illustrated. At 502, a saturation algorithm 14 of a SbW module 22 receives vehicle data 116 from a steering wheel actuator 108 and a road wheel actuator 110. The vehicle data 116 includes a steering wheel angle 112a, a steering wheel torque 112b, and dampening friction 116a. The saturation algorithm 14 determines, at 504, a total self-aligning torque 26 based on the vehicle data 116 and generates, at 506, based on the determined total self-aligning torque 26, a self-aligning torque estimation 24. The saturation algorithm 14 determines, at 508, a pneumatic trail estimation 28 based on the self-aligning torque estimation 24 and a lateral axle force estimation 122 and generates, at 510, a lateral axle saturation 32 based on the pneumatic trail estimation 28. At 512, the saturation algorithm 14 executes, based on the lateral axle saturation 32, a steering output 34. At 514, the SbW module 22 issues a notification 50 corresponding to the steering output 34.

Referring again to FIGS. 1-5, the SbW system 10 may advantageously adjust the steering ratio 20 based on the lateral axle saturation 32 and the self-aligning torque estimation 24. The SbW system 10 may also automatically execute the emulated torque feedback adjustment 38 in response to the lateral axle saturation 32 and the self-aligning torque estimation 24. With either response, the SbW system 10 advantageously stabilizes the vehicle 100 relative to the roadway 200 by minimizing the effect of the steering wheel 102 (i.e., the steering angle 112a and/or steering wheel torque 112b) on the road wheels 104. Thus, the driver may experience minimal disruption in driving patterns while operating the vehicle 100, while performance and stability of the vehicle 100 are improved. Further, the issuance of the notification 50 via the saturation algorithm 14 provides feedback to the driver of the changes executed by the saturation algorithm 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that when executed by data processing hardware causes the data processing hardware to perform operations comprising:
receiving, at a saturation algorithm of a steer-by-wire (SbW) module, vehicle data from a steering wheel actuator and a road wheel actuator;
generating, based on the received vehicle data, a self-aligning torque estimation;
determining, via the saturation algorithm, a pneumatic trail estimation based on the self-aligning torque estimation and a lateral axle force estimation;
generating, via the saturation algorithm, a lateral axle saturation based on the pneumatic trail estimation;
executing, based on the lateral axle saturation, a steering output via the saturation algorithm;
altering, based on the steering output, a steering ratio of a steering wheel relative to road wheels; and
executing, via the SbW module, a notification corresponding to the steering output.

2. The method of claim 1, wherein the vehicle data includes a steering wheel angle, a steering wheel torque, and dampening friction.

3. The method of claim 1, wherein generating the self-aligning torque estimation includes determining a total self-aligning torque based on the vehicle data.

4. The method of claim 1, wherein executing the steering output includes executing a steering ratio adjustment via the saturation algorithm.

5. The method of claim 4, wherein the steering ratio adjustment includes a ratio between a steering wheel angle and a road wheel angle.

6. The method of claim 1, wherein executing the steering output includes executing a torque feedback adjustment.

7. The method of claim 6, wherein executing the torque feedback adjustment includes increasing a torque stiffness defined at a steering wheel.

8. The method of claim 1, wherein executing the notification includes issuing a haptic notification at one or more of a steering wheel and a driver seat of a vehicle.

9. The method of claim 1, wherein executing the notification includes issuing the notification at a head-up display of a vehicle.

10. A steer-by-wire (SbW) system for a vehicle, the SbW system comprising:
data processing hardware; and
memory hardware in communication with the data processing hardware, the memory hardware storing instructions that when executed on the data processing hardware cause the data processing hardware to perform operations comprising:
receiving, at a saturation algorithm of a steer-by-wire (SbW) module, vehicle data from a steering wheel actuator and a road wheel actuator;
generating, based on the received vehicle data, a self-aligning torque estimation;
determining, via the saturation algorithm, a pneumatic trail estimation based on the self-aligning torque estimation and a lateral axle force estimation;
generating, via the saturation algorithm, a lateral axle saturation based on the pneumatic trail estimation;
executing, based on the lateral axle saturation, a steering output via the saturation algorithm;
altering, based on the steering output, a steering ratio of a steering wheel relative to road wheels; and
executing, via the SbW module, a notification corresponding to the steering output.

11. The SbW system of claim 10, wherein the vehicle data includes a steering wheel angle, a steering wheel torque, and dampening friction.

12. The SbW system of claim 10, wherein executing the steering output includes executing a steering ratio adjustment via the saturation algorithm.

13. The SbW system of claim 12, wherein the steering ratio adjustment includes a ratio between a steering wheel angle and a road wheel angle.

14. The SbW system of claim 10, wherein executing the steering output includes executing a torque feedback adjustment.

15. The SbW system of claim 14, wherein executing the torque feedback adjustment includes increasing a torque stiffness defined at a steering wheel.

16. The SbW system of claim 10, wherein executing the notification includes issuing a haptic notification at one or more of a steering wheel and a driver seat of a vehicle.

17. The SbW system of claim 10, wherein executing the notification includes issuing the notification at a head-up display of a vehicle.

18. A steer-by-wire (SbW) system for a vehicle, the SbW system comprising:
data processing hardware; and
memory hardware in communication with the data processing hardware, the memory hardware storing instructions that when executed on the data processing hardware cause the data processing hardware to perform operations comprising:
receiving, at a saturation algorithm of a steer-by-wire (SbW) module, vehicle data from a steering wheel actuator and a road wheel actuator, the vehicle data including a steering wheel angle, a steering wheel torque, and dampening friction;
determining, via the saturation algorithm, a total self-aligning torque based on the vehicle data;
generating, based on the determined total self-aligning torque, a self-aligning torque estimation;
determining, via the saturation algorithm, a pneumatic trail estimation based on the self-aligning torque estimation and a lateral axle force estimation;
generating, via the saturation algorithm, a lateral axle saturation based on the pneumatic trail estimation;
executing, based on the lateral axle saturation, a steering output via the saturation algorithm;
altering, based on the steering output, a steering ratio of a steering wheel relative to road wheels; and
issuing, via the SbW module, a notification corresponding to the steering output.

19. The SbW system of claim 18, wherein executing the steering output includes executing a steering ratio adjustment via the saturation algorithm, the steering ratio adjustment including a ratio between a steering wheel angle and a road wheel angle.

20. The SbW system of claim 18, wherein executing the steering output includes executing a torque feedback adjustment and increasing a torque stiffness defined at a steering wheel.
